(19) United States
(12) Patent Application Publication
(10) Pub. No.: US 2020/0130419 A1
(43) Pub. Date: Apr. 30, 2020

(54) Pneumatic Tire

(71) Applicant: The Yokohama Rubber Co., LTD., Minato-ku, Tokyo (JP)

(72) Inventor: Mina Fukuda, Hiratsuka-shi, Kanagawa (JP)

(21) Appl. No.: 16/620,423

(22) PCT Filed: Mar. 15, 2018
(86) PCT No.: PCT/JP2018/010348

§ 371 Date: Dec. 6, 2019

(30) Foreign Application Priority Data
Jun. 12, 2017 (JP) 2017-115457

(51) Int. Cl. B60C 11/13

(52) U.S. Cl. CPC B60C 11/1353; B60C 2011/1361

(57) ABSTRACT

A pneumatic tire rotatable around a tire rotation axis includes a tread portion provided with a circumferential main groove extending in a tire circumferential direction, and a projecting body provided on a groove bottom of the circumferential main groove and projecting outward from the groove bottom in a tire radial direction. The projecting body includes a first portion connected to the groove bottom and a second portion disposed outward from the first portion in the tire radial direction. In a tire lateral direction, a dimension of the first portion is W1 and a dimension of the second portion is W2, and a condition W1<W2 is satisfied.

### TECHNICAL FIELD

The present technology relates to a pneumatic tire.

### BACKGROUND ART

A tread portion of a pneumatic tire may be provided with a circumferential main groove extending in a tire circumferential direction. In a case where a stone enters the circumferential main groove and is trapped, the stone may crack a groove bottom or reach and damage a belt layer. The phenomenon in which the trapped stone causes the cracking of the groove bottom or the damage to the belt layer is referred to as stone drilling. The occurrence of stone drilling may degrade the durability of the pneumatic tire or make retreading of the pneumatic tire difficult.

### SUMMARY

A technique has been contrived in which a projecting body is provided on the groove bottom of the circumferential main groove to suppress the occurrence of stone drilling.

By providing the projecting body on the groove bottom, the occurrence of stone drilling is suppressed. However, depending on the shape of the projecting body, the effect of suppressing the occurrence of stone drilling may not be sufficiently exhibited.

The present technology provides a pneumatic tire capable of suppressing the occurrence of stone drilling.

According to an aspect of the present technology, a pneumatic tire rotating or rotatable around a tire rotation axis is provided, the pneumatic tire including a tread portion provided with a circumferential main groove extending in a tire circumferential direction, and a projecting body provided on a groove bottom of the circumferential main groove and projecting outward from the groove bottom in a tire radial direction, wherein the projecting body includes a first portion connected to the groove bottom and a second portion disposed outward from the first portion in the tire radial direction, and, in a tire lateral direction, where a dimension of the first portion is W1 and a dimension of the second portion is W2, a condition below is satisfied:

W1<W2 (1).

According to the aspect of the present technology, even in a case where a stone enters from an opening of the circumferential main groove toward an end of the groove bottom, arrival of the stone at the groove bottom is suppressed by the second portion having a large dimension in the tire lateral direction. Accordingly, the occurrence of stone drilling is suppressed. Additionally, since the first portion connected to the groove bottom has a small dimension, the projecting body can be sufficiently deflected. The deflected projecting body inhibits the stone from reaching the groove bottom. Additionally, the small dimension of the first portion reduces the amount of rubber used in the projecting body. A reduced amount of rubber used suppresses an increase in costs and also suppresses degrading of heat dissipation performance of the tread portion. Additionally, the small dimension of the first portion suppresses degrading of drainage performance of the circumferential main groove.

In the aspect of the present technology, the second portion may include an end surface that is flat in a meridian cross-section extending through the tire rotation axis.

Thus, even in a case where a stone enters from the opening of the circumferential main groove toward the center of the groove bottom, the end surface effectively suppresses arrival of the stone at the groove bottom.

In the aspect of the present technology, the second portion may include a pair of leading edge portions that are adjacent in the tire lateral direction with a valley portion interposed between the leading edge portions.

Accordingly, the rigidity of the second portion is appropriately set, and the leading edge portion can be appropriately deflected. Since the leading edge portions are deflected, even in a case where a stone enters from the opening of the circumferential main groove toward the end of the groove bottom, the leading edge portions effectively suppress arrival of the stone at the groove bottom.

In the aspect of the present technology, in the tire radial direction, where a distance between the groove bottom and the valley portion is hb, and a distance between the groove bottom and the opening of the circumferential main groove is H, a condition below may be satisfied,

0.1≤hb/H≤0.5 (2).

Accordingly, the occurrence of stone drilling is effectively suppressed. hb/H being smaller than 0.1 means a small distance hb and an insufficient height of the projecting body. In a case where hb/H is smaller than 0.1, the stone is likely to crack the projecting body and to reach the groove bottom. On the other hand, hb/H being larger than 0.5 means a large distance hb and an excessively large height of the projecting body. In a case where hb/H is larger than 0.5, the amount of rubber used in the projecting body increases. An increased amount of rubber used increases the costs and degrades heat dissipation performance of the tread portion. Satisfying the condition of Formula (2) allows effective suppression of arrival of a stone at the groove bottom while suppressing an increase in the amount of rubber.

In the aspect of the present technology, in the tire lateral direction, where a distance between and a boundary between the groove bottom and the first portion and a groove wall of the circumferential main groove is d, and a distance between the boundary and each of the leading edge portions is e, a condition below may be satisfied:

0.50≤e/d≤0.95 (3).

Accordingly, the occurrence of stone drilling is effectively suppressed. e/d being smaller than 0.50 means an excessively small distance e or an excessively large distance d. In a case where e/d is smaller than 0.50, the projecting body is likely to have difficulty capturing a stone entering toward the end of the groove bottom. e/d being larger than 0.95 means an excessively large distance e or an excessively small distance d. In a case where e/d is larger than 0.95, the projecting body has excessively low rigidity at the valley portion, and is thus likely to have difficulty capturing a stone entering toward the end of the groove bottom. Satisfying the condition of Formula (3) allows the projecting body to capture a stone entering toward the end of the groove bottom. Thus, the occurrence of stone drilling is effectively suppressed.

In the aspect of the present technology, in the tire lateral direction, where a dimension of the first portion at the boundary between the first portion and the groove bottom is f, and a dimension of the opening of the circumferential main groove is g, a condition below may be satisfied:

0.1≤f/g≤0.8 (4).

Accordingly, the occurrence of stone drilling is effectively suppressed. f/g being smaller than 0.1 means an excessively small dimension for an excessively large dimension g. In a case where f/g is smaller than 0.1, the projecting body has excessively low rigidity at the first portion, and is thus likely to have difficulty capturing a stone entering toward the end of the groove bottom. f/g being larger than 0.8 means an excessively large dimension f or an excessively small dimension g. In a case where f/g is larger than 0.8, the projecting body has excessively high rigidity at the first portion, and is thus likely to have difficulty being sufficiently deflected and capturing a stone entering toward the end of the groove bottom. Satisfying the condition of Formula (4) allows the projecting body to capture a stone entering toward the end of the groove bottom. Thus, the occurrence of stone drilling is effectively suppressed.

In the aspect of the present technology, in a meridian cross-section extending through the tire rotation axis, where an angle formed between a first line connecting the valley portion and each of the leading edge portions and a second line parallel to the tire rotation axis is 0, a condition below may be satisfied:

5°≤θ≤60° (5).

Accordingly, the occurrence of stone drilling is effectively suppressed. The angle θ being smaller than 5° means that the valley portion is excessively widened. In a case where the angle θ is smaller than 5°, the projecting body has excessively low rigidity at the valley portion, and is thus likely to have difficulty capturing a stone entering toward the end of the groove bottom. The angle θ being larger than 60° means that the valley portion is excessively narrowed. In a case the angle θ is larger than 60°, the projecting body has excessively high rigidity at the valley portion, and is thus likely to have difficulty being sufficiently deflected and capturing a stone entering toward the end of the groove bottom. Satisfying the condition of Formula (5) allows the projecting body to capture a stone entering toward the end of the groove bottom. Thus, the occurrence of stone drilling is effectively suppressed.

In the aspect of the present technology, the second portion may include, at a central portion in the tire lateral direction, a ridge portion projecting outward in the tire radial direction.

Accordingly, the rigidity of the shoulder land portion is ensured. Thus, even in a case where a stone hits the projecting body, damage to the projecting body is sufficiently suppressed.

In the aspect of the present technology, the second portion may include overhang portions connected to the first portion via corner portions and projecting outward from the first portion in the tire lateral direction.

Accordingly, slight deflection of the first portion brings the overhang portions into contact with the respective groove walls. This blocks a pathway of entry into the groove bottom, thus inhibiting a stone from reaching the groove bottom.

In the aspect of the present technology, a plurality of the circumferential main grooves may be formed in a tire lateral direction, and each one of the circumferential main grooves provided with the projecting body may be the circumferential main groove located at a center of the tread portion in the tire lateral direction or one of the plurality of circumferential main grooves that is located closest to the center of the tread portion in the tire lateral direction.

Accordingly, the occurrence of stone drilling is effectively suppressed. Stone trapping is likely to occur in the circumferential main groove located at the center in the tire lateral direction or in the circumferential main groove closest to the center in the tire lateral direction. By providing the projecting body in the circumferential main groove where stone trapping is likely to occur, the occurrence of stone drilling is effectively suppressed.

An aspect of the present technology provides a pneumatic tire capable of suppressing the occurrence of stone drilling.

### BRIEF DESCRIPTION OF DRAWINGS

FIG. 1 is a meridian cross-sectional view illustrating a main portion of a pneumatic tire according to a first embodiment.

FIG. 2 is a meridian cross-sectional view illustrating an example of a projecting body according to the first embodiment.

FIG. 3 is a diagram illustrating an example of the effect of the projecting body according to the first embodiment.

FIGS. 4A and 4B are diagrams illustrating an example of a projecting body according to a comparative example.

FIG. 5 is a meridian cross-sectional view illustrating an example of a projecting body according to a second embodiment.

FIG. 6 is an enlarged meridian cross-sectional view illustrating an example of a projecting body according to the second embodiment.

FIG. 7 is an enlarged meridian cross-sectional view illustrating an example of a projecting body according to a third embodiment.

FIG. 8 is an enlarged meridian cross-sectional view illustrating an example of a projecting body according to a fourth embodiment.

FIGS. 9A-9B include a table indicating an example of results of evaluation tests on pneumatic tires with projecting bodies.

### DETAILED DESCRIPTION

Embodiments according to the present technology will be described with reference to the drawings. However, the present technology is not limited to those embodiments. Components described in the embodiments below can be combined together. Additionally, some of the components may be omitted.

Herein, “tire lateral direction” refers to the direction that is parallel to a tire rotation axis of a pneumatic tire. “Inward in the tire lateral direction” refers to the direction toward a tire equatorial plane in the tire lateral direction. “Outward in the tire lateral direction” refers to the direction away from the tire equatorial plane in the tire lateral direction. Additionally, “tire radial direction” refers to the direction orthogonal to the tire rotation axis. “Inward in the tire radial direction” refers to the direction toward the tire rotation axis in the tire radial direction. “Outward in the tire radial direction” refers to the direction away from the tire rotation axis in the tire radial direction. “Tire circumferential direction” refers to the direction of rotation about the tire rotation axis.

“Tire equatorial plane” refers to a plane orthogonal to the tire rotation axis and passing through the center of the tire in the tire lateral direction. “Tire equator line” refers to a center line where the tire equatorial plane and a surface of the tread portion of the pneumatic tire intersect.

### First Embodiment

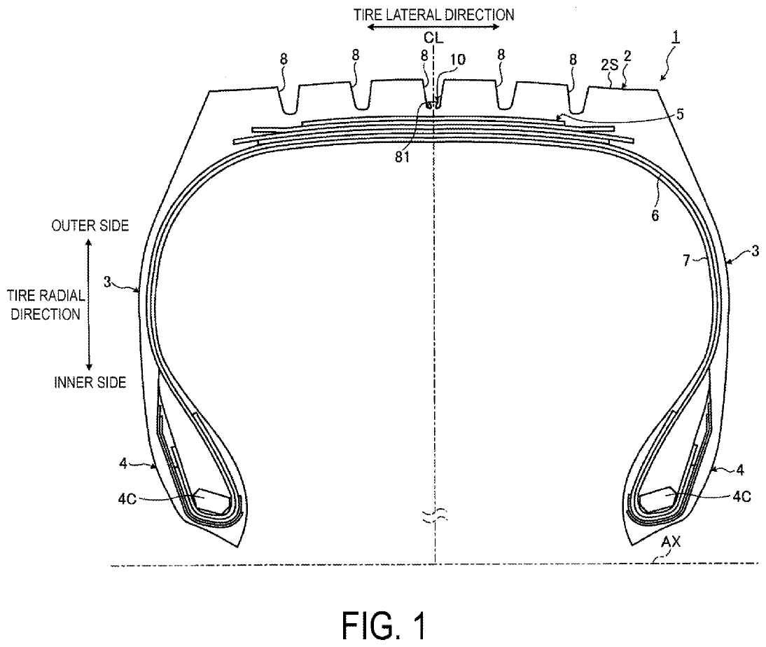

FIG. 1 is a meridian cross-sectional view illustrating a main portion of a tire 1 according to the present embodiment. “Meridian cross-section” refers to a cross-section extending through a tire rotation axis AX. The tire 1 is a pneumatic tire and is a tubeless tire. The tire 1 rotates about the tire rotation axis AX while mounted on a vehicle.

In the present embodiment, the tire 1 is a heavy duty tire mounted on a truck and a bus. “Track and bus tires (heavy duty tires)” refer to tires defined in Chapter C of JATMA YEAR BOOK issued from Japan Automobile Tyre Manufacturers Association. Note that the tire 1 may be mounted on a passenger vehicle or on a light truck.

As illustrated in FIG. 1, the tire 1 includes a tread portion 2 including tread rubber, and side portions 3 including side rubber. The tread portion 2 includes a tread surface 2S contacting a road surface while a vehicle on which the tire 1 is mounted is traveling. The side portions 3 are disposed on both sides of the tread portion 2 in the tire lateral direction.

Additionally, the tire 1 includes bead portions 4 provided inward of the side portions 3 in the tire radial direction, a belt layer 5 provided inward of the tread portion 2 in the tire radial direction, a carcass 6 supporting the tread portion 2 and the side portions 3, and an innerliner 7 facing an inner space in the tire 1.

The bead portions 4 are mounted on a rim of a vehicle. In the present embodiment, the bead portions 4 are mounted on a specified rim with a 15° taper. “Specified rim” includes at least one of an “applicable rim” specified by JATMA, a “Design Rim” specified by the Tire and Rim Association, Inc. (TRA), or a “Measuring Rim” specified by the European Tyre and Rim Technical Organisation (ETRTO).

Each of the bead portions 4 includes a bead core 4C. The bead core 4C includes a steel wire rolled in a ring shape.

The belt layer 5 includes a multilayer of a plurality of belts. Each of the belts includes a belt cord made of steel wire or organic fiber, and coating rubber covering the belt cord. The plurality of belts are layered so as to dispose the belt cords at different angles.

The carcass 6 is disposed inward from the belt layer 5 in the tire radial direction. Additionally, the carcass 6 is disposed inward of each side portion 3 inward in the tire lateral direction. The carcass 6 is supported by a pair of bead cores 4C disposed on both sides of the tire in the tire lateral direction. The carcass 6 spans an area between a pair of bead cores 4 C in a toroidal shape.

A circumferential main groove 8 is formed in the tread portion 2. The circumferential main groove 8 extends in the tire circumferential direction. A plurality of the circumferential main grooves 8 are formed in the tire lateral direction. In the present embodiment, five circumferential main grooves 8 are formed in the tire lateral direction. A wear indicator that is a projection for visually determining a wear state of the tread portion 2 is provided in the circumferential main grooves 8.

One of the five circumferential main grooves 8 that is formed in the center of the tire in the tire lateral direction is located at the tire equatorial plane CL, which is the center of the tread portion 2 in the tire lateral direction.

A projecting body 10 is provided on a groove bottom 81 of the circumferential main groove 8 located at the tire equatorial plane CL. The projecting body 10 protrudes outward from the groove bottom 81 of the circumferential main groove 8 in the tire radial direction.

In the present embodiment, the projecting body 10 is provided in one of the circumferential main grooves 8 that is located at the tire equatorial plane CL. The projecting body 10 is not provided in the four circumferential main grooves 8 that are not located at the tire equatorial plane CL.

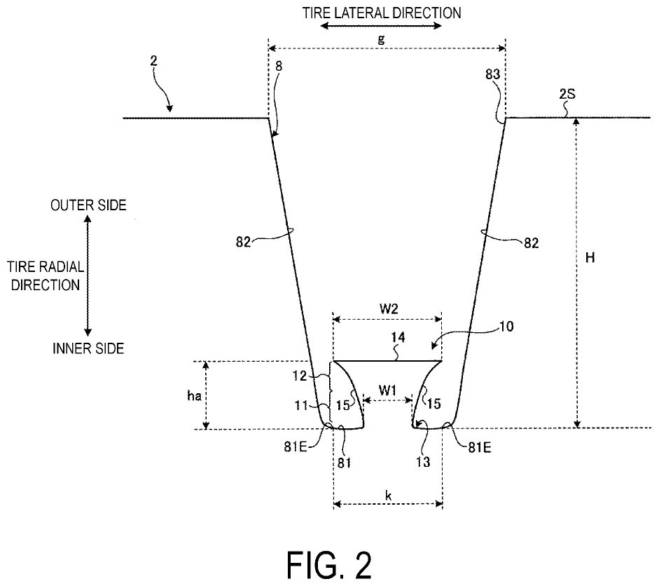

FIG. 2 is a meridian cross-sectional view illustrating an example of the projecting body 10 according to the present embodiment. As illustrated in FIG. 2, the projecting body 10 is provided in the groove bottom 81 of the circumferential main groove 8 and protrudes outward from the groove bottom 81 in the tire radial direction. The circumferential main groove 8 includes the groove bottom 81, groove walls 82 disposed on both sides of the groove bottom 81 in the tire lateral direction, and an opening 83. End portions inward in the tire radial direction of the groove wall 82 are connected to respective end portions in the tire lateral direction of the groove bottom 81. The opening 83 is defined by end portions in the tire radial direction of the groove walls 82.

The projecting body 10 is formed from the same rubber (tread rubber) as that of the tread portion 2. The tread portion 2 and the projecting body 10 are integral.

The projecting body 10 includes a first portion 11 connected to the groove bottom 81, and a second portion 12 disposed outward from the first portion 11 in the tire radial direction.

The projecting body 10 is provided such that, in the tire lateral direction, where the dimension of the first portion 11 is W1 and the dimension of the second portion 12 is W2, a condition below is satisfied:

W1<W2 (1).

The first portion 11 includes a root 13 of the projecting body 10 connected to the groove bottom 81. The second portion 12 includes an end surface 14 that is flat in a meridian cross-section. In other words, the end surface 14 is linear in the meridian cross-section. In the meridian cross-section, the end surface 14 is parallel to the rotation axis AX. In the tire lateral direction, the root 13 has the smallest dimension, and the end surface 14 has the largest dimension.

The projecting body 10 includes side surfaces 15 connecting corresponding end portions in the tire lateral direction of the end surface 14 to the root 13. The side surfaces 15 are curved in the meridian cross-section. In the present embodiment, the side surfaces 15 are recessed while extending closer to the tire equatorial plane CL. Note that the side surfaces 15 may protrude away from the tire equatorial plane CL or may be linear in the meridian cross-section.

The projecting body 10 is separated from the groove walls 82. Additionally, the end surface 14 is disposed inward from the opening 83 in the tire radial direction.

A distance H between the groove bottom 81 and the opening 83 in the tire radial direction is from 10 mm to 25 mm. The distance H is the groove depth of the circumferential main groove 8. In the tire radial direction, a distance ha between the groove bottom 81 and the end surface 14 is at least 2 mm. Note that it is sufficient that the end surface 14 is disposed inward from the opening 83 in the tire radial direction. That is, it is sufficient that the distance ha is smaller than the distance H.

In the tire lateral direction, a dimension g of the opening 83 is from 8 mm to 15 mm. The dimension g is the groove width of the circumferential main groove 8. In the tire lateral direction, a dimension k of the groove bottom 81 is from 4 mm and to 15 mm.

In the present embodiment, the projecting body 10 extends in the tire circumferential direction. In other words, in a cross section orthogonal to the rotation axis AX, the projecting body 10 is annular. Note that a plurality of the projecting bodies 10 may be provided in the tire circumferential direction. In other words, the projecting bodies 10 may be provided discontinuously in the tire circumferential direction.

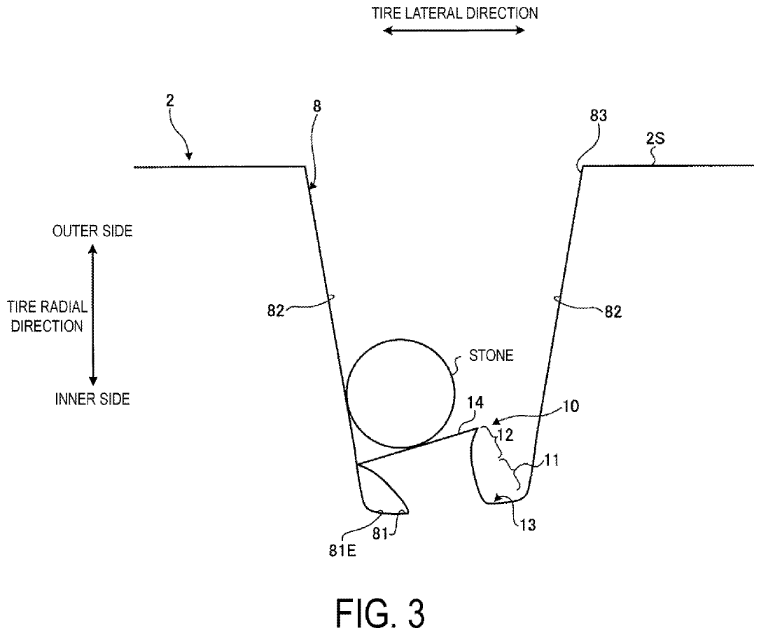

FIG. 3 is a diagram illustrating an example of the effect of the projecting body 10 according to the present embodiment. The second portion 12, which has a large dimension W2 in the tire lateral direction, is disposed covering the groove bottom 81. Accordingly, as illustrated in FIG. 3, in a case where a stone enters from the opening 83 of the circumferential main groove 8 toward the groove bottom 81, the projecting body 10 inhibits arrival of the stone at the groove bottom 81. For example, even in a case where a stone enters from the opening 83 toward a lateral end 81E of the groove bottom 81, the second portion 12 suppresses arrival of the stone at the groove bottom 81.

Additionally, in the present embodiment, the first portion 11 connected to the groove bottom 81 has a small dimension W1, and thus, as illustrated in FIG. 3, the first portion 11 of the projecting body 10 having come into contact with the stone can be sufficiently deflected. Since the projecting body 10 is deflected and the second portion 12 comes into contact with the groove wall 82, the pathway of entry into the groove bottom 81 is blocked, inhibiting the stone from reaching the groove bottom 81.

As described above, according to the present embodiment, the projecting body 10 includes the first portion 11 connected to the groove bottom 81, and the second portion 12 disposed outward from the first portion 11 in the tire radial direction. With the dimension W1 of the first portion 11 and the dimension W2 of the second portion 12 in the tire lateral direction, the projecting body 10 is formed so as to satisfy the condition of Formula (1). Accordingly, even in a case where a stone enters from the opening 83 of the circumferential main groove 8 toward the end 81E of the groove bottom 81, arrival of the stone at the groove bottom 81 is suppressed by the second portion 12 having a large dimension W2 in the tire lateral direction. Accordingly, the occurrence of stone drilling is suppressed. Additionally, since the first portion 11 connected to the groove bottom 81 has a small dimension W1, the projecting body 10 can be sufficiently deflected. The deflected projecting body 10 blocks the pathway of entry into the groove bottom 81, inhibiting the stone from reaching the groove bottom 81.

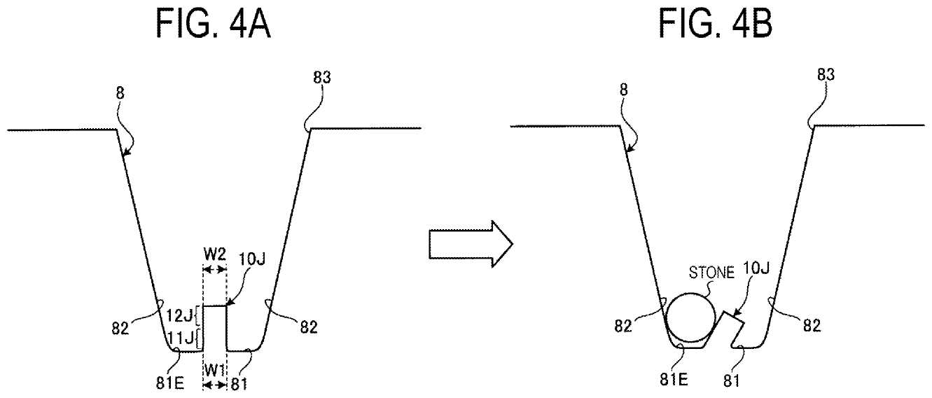

FIGS. 4A and 4B are diagrams illustrating an example of a projecting body 10J according to a comparative example. As illustrated in FIG. 4A, in the tire lateral direction, the dimension W1 of a first portion 11J of the projecting body 10J is equal to the dimension W2 of a second portion 12J of the projecting body 10J. In other words, the lateral dimension of the projecting body 10J is uniform in the tire radial direction.

As illustrated in FIG. 4A, the projecting body 10J fails to cover a portion of the groove bottom 81 including the ends 81E. Thus, in a case where a stone enters from the opening 83 of the circumferential main groove 8 toward the end 81E of the groove bottom 81, then, as illustrated in FIG. 4B, the stone is likely to enter between the projecting body 10J and the corresponding groove wall 82 and to reach the groove bottom 81.

An increased lateral dimension of the projecting body 10J reduces the size of a gap between the projecting body 10J and each groove wall 82, thus inhibiting the stone from entering between the projecting body 10J and each groove wall 82. However, a simply increased lateral dimension of the projecting body 10J increases the amount of rubber used in the projecting body 10J. An increased amount of rubber used increases costs and degrades heat dissipation performance of the tread portion 2. Additionally, an increased lateral dimension of the projecting body 10J degrades drainage performance of the circumferential main groove 8.

According to the present embodiment, the reduced size W1 of the first portion 11 including the root 13 reduces the amount of rubber used in the projecting body 10. A reduced amount of rubber used suppresses an increase in costs and degrading of the heat dissipation performance of the tread portion 2. Additionally, the reduced dimension W1 of the first portion 11 suppresses degrading of the drainage performance of the circumferential main groove 8.

Additionally, in the present embodiment, the second portion 12 includes the end surface 14 that is flat in a meridian cross-section extending through the tire rotation axis AX. Accordingly, even in a case where a stone enters from the opening 83 of the circumferential main groove 8 toward the center of the groove bottom 81 in the tire lateral direction, the end surface 14 effectively suppresses arrival of the stone at the groove bottom 81.

Additionally, in the present embodiment, a plurality of the circumferential main grooves 8 are formed in the tire lateral direction. The circumferential main groove 8 provided with the projecting body 10 is the circumferential main groove 8 located at the tire equatorial plane CL, which indicates the center of the tread portion 2 in the tire lateral direction.

Accordingly, the occurrence of stone drilling is effectively suppressed. Stone trapping is likely to occur in the circumferential main groove 8 closest to the circumferential main groove 8 located at the tire equatorial plane CL. By providing the projecting body 10 in the circumferential main groove 8 where stone trapping is likely to occur, the occurrence of stone drilling is effectively suppressed.

### Second Embodiment

A second embodiment will now be described. Herein, components identical to those in the above-described embodiment have the same reference signs, and descriptions of the components will be simplified or omitted.

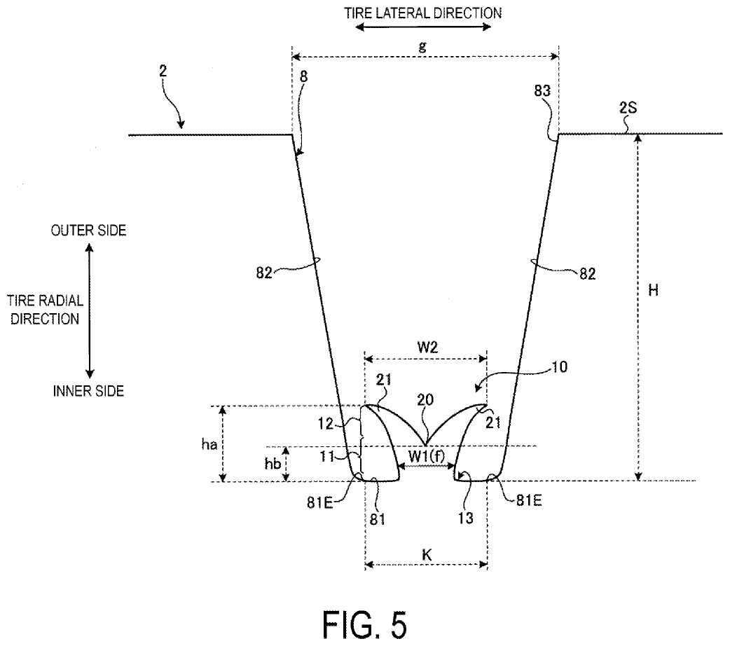

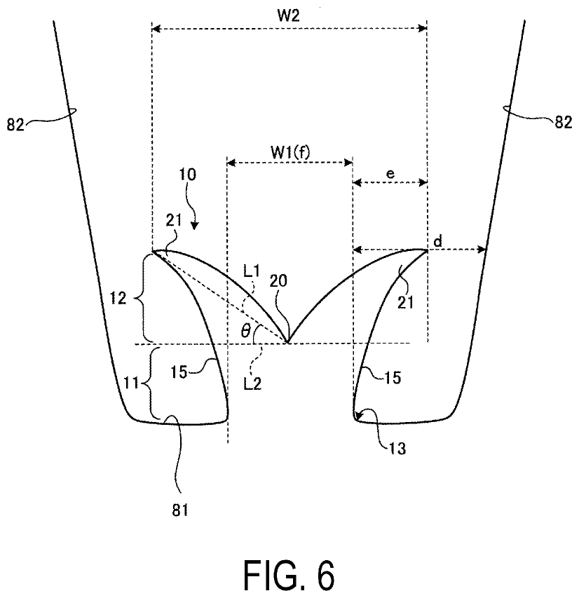

FIG. 5 is a meridian cross-sectional view illustrating an example of the projecting body 10 according to the present embodiment. FIG. 6 is an enlarged meridian cross-sectional view illustrating an example of the projecting body 10 according to the present embodiment. As illustrated in FIGS. 5 and 6, the projecting body 10 includes the first portion 11 connected to the groove bottom 81 and the second portion 12 disposed outward from the first portion 11 in the tire radial direction. In the tire lateral direction, where the dimension of the first portion 11 is W1 and the dimension of the second portion 12 is W2, the condition of Formula (1) described above is also satisfied in the present embodiment.

In the present embodiment, the second portion 12 includes a pair of leading edge portions 21 that are adjacent in the tire lateral direction with a valley portion 20 interposed between the leading edge portions 21. In a meridian cross-section, the leading edge portions 21 of the pair of leading edge portions 21 are substantially identical in external shape and dimension. In other words, in the meridian cross-section, one of the leading edge portions 21 and the other leading edge portion 21 are in a line symmetrical relationship with respect to a reference line that passes through the valley portion 20 and that is orthogonal to the tire rotation axis AX.

In the tire radial direction, where a distance between the groove bottom 81 and the valley portion 20 in the tire radial direction is hb and a distance between the groove bottom 81 and the opening 83 of the circumferential main groove 8 is H, the projecting body 10 is formed so as to satisfy a condition below:

0.1≤hb/H≤0.5 (2).

In the tire lateral direction, where a distance between the root 13, which is the boundary between the groove bottom 81 and the first portion 11, and each groove wall 82 of the circumferential main groove 8 is d, and a distance between the root 13, which is the boundary, and each leading edge portion 21 is e, the projecting body 10 is formed so as to satisfy a condition below:

0.50≤e/d≤0.95 (3).

In the tire lateral direction, where the dimension of the first portion 11 at the root 13, which is the boundary between the groove bottom 81 and the first portion 11 is f, and the dimension of the opening 83 of the circumferential main groove 8 is g, the projecting body 10 is formed so as to satisfy a condition below:

0.1≤f/g≤0.8 (4).

In a meridian cross-section, where an angle formed between a first line L1 connecting the valley portion 20 to each leading edge portion 21 and a second line L2 that passes through the valley portion 20 and that is parallel to the tire rotation axis AX is θ, the projecting body 10 is formed so as to satisfy a condition below:

5°≤θ≤60° (5).

As described above, according to the present embodiment, the second portion 12 includes the pair of leading edge portions 21 that are adjacent in the tire lateral direction with the valley portion 20 interposed between the leading edge portions 21.

Thus, the rigidity of the second portion 12 is made appropriate, and the leading edge portions 21 can be appropriately deflected. The leading edge portions 21 are deflected to reduce the distance between each leading edge portion 21 and the corresponding groove wall 82, and thus, even in a case where a stone enters from the opening 83 of the circumferential main groove 8 toward the end 81E of the groove bottom 81, the pathway of entry into the groove bottom 81 is blocked. Accordingly, the leading edge portions 21 effectively suppress arrival of the stone at the groove bottom 81.

Additionally, in the present embodiment, in the tire radial direction, where a distance between the groove bottom 81 and the valley portion 20 is hb and a distance between the groove bottom 81 and the opening 83 of the circumferential main groove 8 is H, the projecting body 10 is formed so as to satisfy the condition of formula (2).

Accordingly, the occurrence of stone drilling is effectively suppressed. hb/H being smaller than 0.1 means a small distance hb and an insufficient height of the projecting body 10 (dimension in the tire radial direction). In a case where hb/H is smaller than 0.1, the stone is likely to crack the projecting body 10 and to reach the groove bottom 81. On the other hand, hb/H being larger than 0.5 means a large distance hb and an excessively large height of the projecting body 10. In a case where hb/H being is larger than 0.5, the amount of rubber used in the projecting body 10 increases. An increased amount of rubber used increases the costs and degrades the heat dissipation performance of the tread portion 2. Satisfying the condition of Formula (2) allows effective suppression of arrival of a stone at the groove bottom 81 while suppressing an increase in the amount of rubber.

Additionally, in the present embodiment, in the tire lateral direction, where the distance between the root 13, which is the boundary between the groove bottom 81 and the first portion 11, and each groove wall 82 of the circumferential main groove 8 is d and the distance between the root 13 and each leading edge portion 21 is e, the projecting body 10 is formed so as to satisfy the condition of Formula (3).

Accordingly, the occurrence of stone drilling is effectively suppressed. e/d being smaller than 0.50 means excessively small distance e or an excessively large distance d. In a case where e/d is smaller than 0.50, the projecting body 10 is likely to have difficulty capturing a stone entering toward the end 81E of the groove bottom 81. e/d being larger than 0.95 means an excessively large distance e or an excessively small distance d. In a case where e/d is larger than 0.95, the projecting body 10 has excessively low rigidity at the valley portion 20, and is thus likely to have difficulty capturing a stone entering toward the end 81E of the groove bottom 81. Satisfying the condition of Formula (3) allows the projecting body 10 to capture a stone entering toward the ends 81E of the groove bottom 81. Thus, the occurrence of stone drilling is effectively suppressed.

Additionally, in the present embodiment, in the tire lateral direction, where the dimension of the first portion 11 at the root 13, which is the boundary between the groove bottom 81 and the first portion 11 is f, and the dimension of the opening 83 of the circumferential main groove 8 is g, the projecting body 10 is formed so as to satisfy the condition of Formula (4).

Accordingly, the occurrence of stone drilling is effectively suppressed. f/g being smaller than 0.1 means an excessively small dimension for an excessively large dimension g. In a case where f/g is smaller than 0.1, the projecting body 10 has excessively low rigidity at the first portion 11, and is thus likely to have difficulty capturing a stone entering toward the end 81E of the groove bottom 81. f/g being larger than 0.8 means an excessively large dimension f or an excessively small dimension g. In a case where f/g is larger than 0.8, the projecting body 10 has excessively high rigidity at the first portion 11, and is thus likely to have difficulty being sufficiently deflected and capturing a stone entering toward the end 81E of the groove bottom 81. Satisfying the condition of Formula (4) allows the projecting body 10 to capture a stone entering toward the ends 81E of the groove bottom 81. Thus, the occurrence of stone drilling is effectively suppressed.

Additionally, according to the present embodiment, in a meridian cross-section, where the angle formed between the first line L1 connecting the valley portion 20 to each leading edge portion 21 and the second line L2 that passes through the valley portion 20 and that is parallel to the tire rotation axis AX is θ, the projecting body 10 is formed so as to satisfy the condition of Formula (5).

Accordingly, the occurrence of stone drilling is effectively suppressed. The angle θ being smaller than 5° means that the valley portion 20 are excessively widened. In a case where the angle θ is smaller than 5°, the projecting body 10 has excessively low rigidity at the valley portion 20, and is thus likely to have difficulty capturing a stone entering toward the end 81E of the groove bottom 81. The angle θ being larger than 60° means that the valley portion 20 is excessively narrowed. In a case where the angle θ is larger than 60°, the projecting body 10 has excessively high rigidity at the valley portion 20, and is thus likely to have difficulty being sufficiently deflected and capturing a stone entering toward the end 81E of the groove bottom 81. Satisfying the condition of Formula (5) allows the projecting body 10 to capture a stone entering toward the ends 81E of the groove bottom 81. Thus, the occurrence of stone drilling is effectively suppressed.

### Third Embodiment

A third embodiment will now be described. Herein, components identical to those in the above-described embodiments have the same reference signs, and descriptions of the components will be simplified or omitted.

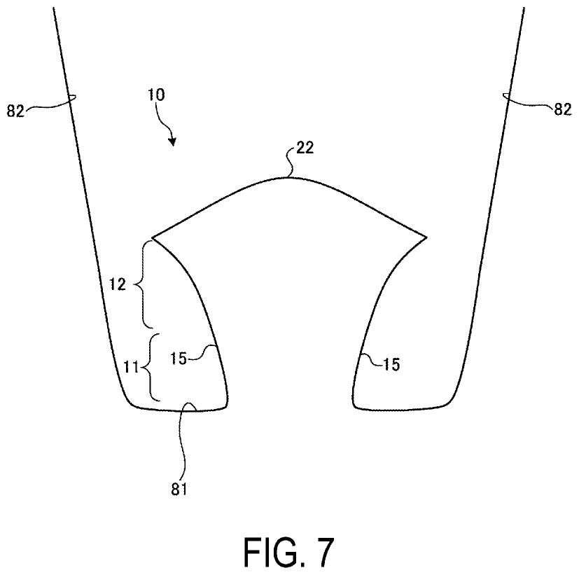

FIG. 7 is an enlarged meridian cross-sectional view illustrating an example of the projecting body 10 according to the present embodiment. As illustrated in FIG. 7, in the present embodiment, the second portion 12 includes a ridge portion 22 projecting outward in the tire radial direction at a central portion of the second portion 12 in the tire lateral direction. The ridge portion 22 is disposed between the pair of side surfaces 15.

According to the present embodiment, the projecting body 10 has an increased height (dimension in the tire radial direction) at the central portion in the tire lateral direction, and thus has appropriate rigidity. Thus, even in a case where a stone hits the projecting body 10, damage to the projecting body 10 is sufficiently suppressed.

### Fourth Embodiment

A fourth embodiment will now be described. Herein, components identical to those in the above-described embodiment have the same reference signs, and descriptions of the constituents will be simplified or omitted.

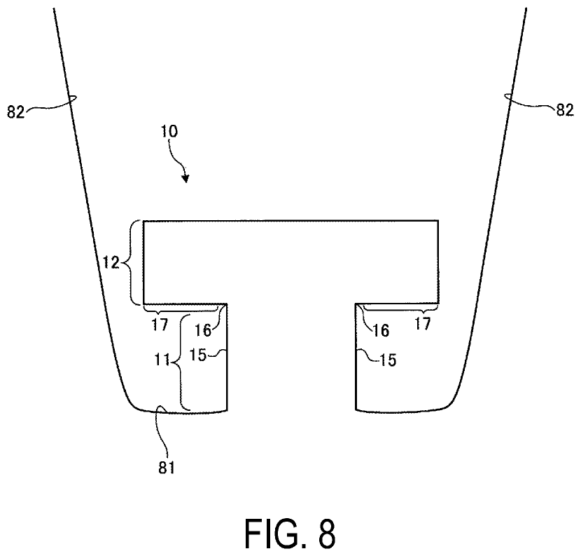

FIG. 8 is an enlarged meridian cross-sectional view illustrating an example of the projecting body 10 according to the present embodiment. As illustrated in FIG. 8, in the present embodiment, the projecting body 10 includes a corner portion 16 on each of the side surfaces 15. The first portion 11 is disposed inward from the corner portion 16 in the tire radial direction. The second portion 12 is disposed outward from the corner portion 16 in the tire radial direction. The second portion 12 is connected to the first portion 11 via the corner portion 16. The second portion 12 includes overhang portions 17 protruding outward from the first portion 11 in the tire lateral direction.

According to the present embodiment, the overhang portions 17 are provided. Thus, slight deflection of the first portion 11 brings each overhang portion 17 into contact with the corresponding groove wall 82. This blocks the pathway of entry into the groove bottom 81, thus inhibiting a stone from reaching the groove bottom 81.

Note that in each of the embodiments described above, the circumferential main groove 8 provided with the projecting body 10 is the circumferential main groove 8 located at the tire equatorial plane CL of the tread portion 2. In a case where none of the plurality of circumferential main grooves 8 formed in the tire lateral direction are located at the tire equatorial plane CL, the projecting body 10 is preferably provided in one of the plurality of circumferential main grooves 8 that is closest to the tire equatorial plane CL.

### Evaluation Tests

FIG. 21 is a table indicating an example of results of evaluation tests on the tire 1 with the projecting bodies 10 Evaluation tests on stone drilling resistance performance conducted on tires according to Comparative Examples and the tires 1 according to the present technology will be described below. In the evaluation tests, a truck on which the tires were mounted was driven on a constant course 10 laps at a speed of 20 km/h, and after the driving, the number of stones having reached the groove bottom of the circumferential main groove was counted. In the evaluation tests, the tires having a tire size of 295/75R22.5 were mounted on rim wheels of 15° tapered specified rims specified by JATMA. The tires were inflated to a specified air pressure specified by JATMA, and subjected to a specified load specified by JATMA.

Superior stone drilling resistance performance is indicated by a smaller number of stones having reached the groove bottom of the circumferential main groove. The results of the evaluation tests are expressed as index values and evaluated, with Comparative Example 1 being assigned as the reference (100), and larger values indicate superior stone drilling resistance performance.

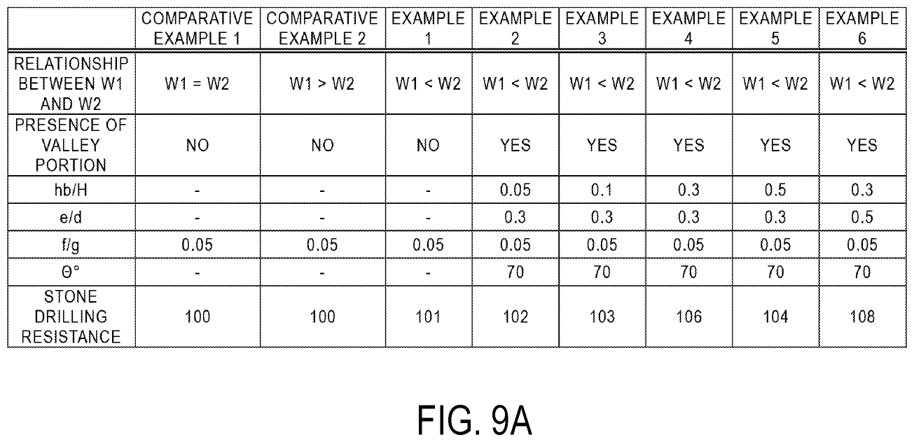

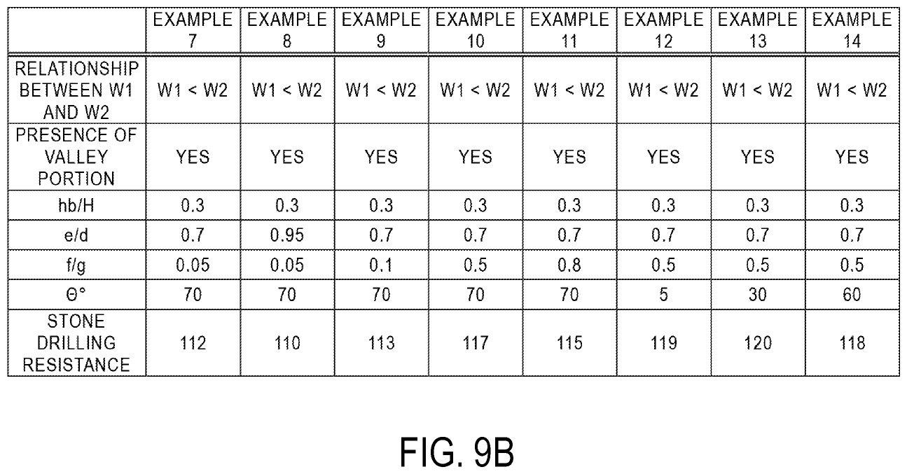

As illustrated in FIGS. 9A-9B, the evaluation tests were performed on the tires according to Comparative Examples 1 and 2 and the tires 1 of Examples 1 to 14, which are the tires 1 according to the present technology. Projecting bodies are provided in all of the circumferential main grooves of these tires. As illustrated in FIGS. 9A-9B, for the tires according to Comparative Examples 1 and 2, the relationship between the dimensions W1 and W2 is out of the technical scope of the present technology.

For Examples 1 to 14, the relationship between dimensions W1 and W2 is within the technical scope of the present technology. The projecting body 10 according to Example 1 includes the flat end surface 14 as described above in the first embodiment. The projecting bodies 10 according to Examples 2 to 14 include the valley portion 20 as described above in the second embodiment.

The projecting bodies 10 according to Examples 1 and 2 fail to satisfy the condition of Formula (2) described above. The projecting bodies 10 according to Examples 3 to 14 satisfy the condition of Formula (2) described above.

The projecting bodies 10 according to Examples 1 to 5 fail to satisfy the condition of Formula (3) described above. The projecting bodies 10 according to Examples 6 to 14 satisfy the condition of Formula (3) described above.

The projecting bodies 10 according to Examples 1 to 8 fail to satisfy the condition of Formula (4) described above. The projecting bodies 10 according to Examples 9 to 14 satisfy the condition of Formula (4) described above.

The projecting bodies 10 according to Examples 1 to 11 fail to satisfy the condition of Formula (5) described above. The projecting bodies 10 according to Examples 12 to 14 satisfy the condition of Formula (5) described above.

As indicated in FIGS. 9A-9B, the tires 1 according to Examples 1 to 14 are superior in stone drilling resistance performance to the tires according to Comparative Examples 1 and 2. Additionally, FIGS. 9A-9B indicate that the stone drilling resistance performance is improved by satisfying the conditions of Formulas (2), (3), (4), and (5).

1. A pneumatic tire rotatable around a tire rotation axis, the pneumatic tire comprising:
a tread portion provided with a circumferential main groove extending in a tire circumferential direction; and
a projecting body provided on a groove bottom of the circumferential main groove and projecting outward from the groove bottom in a tire radial direction, wherein
the projecting body includes a first portion connected to the groove bottom and a second portion disposed outward from the first portion in the tire radial direction, and
in a tire lateral direction, a dimension of the first portion is W1 and a dimension of the second portion is W2, and a condition W1<W2 is satisfied.

2. The pneumatic tire according to claim 1, wherein
the second portion includes an end surface that is flat in a meridian cross-section extending through the tire rotation axis.

3. The pneumatic tire according to claim 1, wherein
the second portion includes a pair of leading edge portions that are adjacent in the tire lateral direction with a valley portion interposed between the leading edge portions.

4. The pneumatic tire according to claim 3, wherein
in the tire radial direction, a distance between the groove bottom and the valley portion is hb, a distance between the groove bottom and an opening of the circumferential main groove is H, and a condition 0.1≤hb/H≤0.5 is satisfied.

5. The pneumatic tire according to claim 3, wherein
in the tire lateral direction, a distance between a boundary between the groove bottom and the first portion and a groove wall of the circumferential main groove is d, a distance between the boundary and each of the leading edge portions is e, and a condition 0.50≤e/d≤0.95 is satisfied.

6. The pneumatic tire according to claim 3, wherein
in the tire lateral direction, a dimension of the first portion at a boundary between the first portion and the groove bottom is f, a dimension of an opening of the circumferential main groove is g, and a condition 0.1≤f/g≤0.8 is satisfied.

7. The pneumatic tire according to claim 3, wherein
in a meridian cross-section extending through the tire rotation axis, an angle formed between a first line connecting the valley portion and the each of the leading edge portions and a second line parallel to the tire rotation axis is θ, and a condition 5°≤θ≤60° is satisfied.

8. The pneumatic tire according to claim 1, wherein
the second portion includes, at a central portion in the tire lateral direction, a ridge portion projecting outward in the tire radial direction.

9. The pneumatic tire according to claim 1, wherein
the second portion includes overhang portions connected to the first portion via corner portions and protruding outward from the first portion in the tire lateral direction.

10. The pneumatic tire according to claim 1, wherein
a plurality of the circumferential main grooves are formed in the tire lateral direction, and
each one of the circumferential main grooves provided with the projecting body is the circumferential main groove located at a center of the tread portion in the tire lateral direction or one of the plurality of the circumferential main grooves that is located closest to the center of the tread portion in the tire lateral direction.

11. The pneumatic tire according to claim 4, wherein
in the tire lateral direction, a distance between a boundary between the groove bottom and the first portion and a groove wall of the circumferential main groove is d, a distance between the boundary and each of the leading edge portions is e, and a condition 0.50≤e/d≤0.95 is satisfied.

12. The pneumatic tire according to claim 11, wherein
in the tire lateral direction, a dimension of the first portion at the boundary between the first portion and the groove bottom is f, a dimension of an opening of the circumferential main groove is g, and a condition 0.1≤f/g≤0.8 is satisfied.

13. The pneumatic tire according to claim 12, wherein
in a meridian cross-section extending through the tire rotation axis, an angle formed between a first line connecting the valley portion and the each of the leading edge portions and a second line parallel to the tire rotation axis is θ, and a condition 5°≤θ≤60° is satisfied.

14. The pneumatic tire according to claim 13, wherein
a plurality of the circumferential main grooves are formed in the tire lateral direction, and
each one of the circumferential main grooves provided with the projecting body is the circumferential main groove located at a center of the tread portion in the tire lateral direction or one of the plurality of the circumferential main grooves that is located closest to the center of the tread portion in the tire lateral direction.
